(19) United States
(12) Patent Application Publication
(10) Pub. No.: US 2026/0338604 A1
(43) Pub. Date: Oct. 29, 2026

(54) Illumination Source Identification

(71) Applicant: James Grassi, Westwood, MA (US)

(72) Inventor: James Grassi, Westwood, MA (US)

(73) Assignee: Spectral Sciences, Inc., Burlington, MA (US)

(21) Appl. No.: 19/540,646

(22) Filed: Feb. 14, 2026

(51) Int. Cl. G01J 3/40; G01J 3/28

(52) U.S. Cl. CPC G01J 3/40; G01J 2003/283

(57) ABSTRACT

A system, device and method for automatically identifying the nature of a source of electromagnetic radiation by providing at least one compact spectrometer that is configured to develop at least wavelength versus intensity spectra from sensed input electromagnetic radiation, and using an artificial intelligence (AI)-based system that is configured to identify, from the spectra, the nature of the source of the input electromagnetic radiation.

### CROSS-REFERENCE TO RELATED APPLICATION

This application claims priority of Provisional Application 63/761,262 filed on Feb. 21, 2025.

### FIELD

The invention relates to a method to employ compact optical spectrometers suitable for autonomous, continuous operation and installation in interior and exterior settings used in conjunction with artificial intelligence/machine learning techniques to both identify flames, fires or other illumination sources and determine the nature of the illumination source.

### BACKGROUND

The application of spectroscopic techniques to characterize flames, heat or other illumination sources has existed for the entire over 100-year history of spectroscopy. The U.S. National Bureau of Standards published flame spectra as early as 1948 and assembled a reference work of flame spectroscopic techniques citing work done in the 1800s as early as 1967. The use of spectrometers to monitor flames and other illumination sources is fundamental science. Multiple commercial instruments exist that use these principals for the purpose of flame detection. However, they typically employ only 1-5 optical band filters from the ultraviolet to the infrared to detect flames/heat sources and provide limited diagnostic ability other than to determine if a flame is present. Patent application publication US 2012/0298667 A1 describes a system that used two narrowband infra-red transmission filters to detect flames in a manner similar to those used in the commercial instruments cited.

Such commercially available limited band general-purpose flame detectors are known to generate false alarms when exposed to cigarettes, non-smoke aerosols or even sunlight. The limited information available to these instruments subsequently limits their ability to discern differences between light sources (e.g. the light of a potentially dangerous flame or that of a cigarette). The use of a spectrometer that provides a near continuum of information across a spectral region offers more information about the nature of the light source as different sources tend to generate different signals. The tendency of different light sources to produce different spectra is common knowledge with spectroscopists and has been exploited for the history of the science. However, to be useful a method to automatically associate a spectrum with its source is required. This is a particularly difficult problem when the spectra are a mixture of several different sources. Methods to associate spectral signatures both singular in nature and convolutions of multiple signals are a subject unto itself and the source of numerous publications.

U.S. Pat. No. 11,162,843 B2 and US patent application publication 2020/0370958 A1 describe the use of spectrometers for applications similar to that proposed herein but are so broad in scope that they attempt to extend the use of spectrometers to gather “information” without any mention as to how the information is to be processed into useful results and make no reference to the use of these devices for the explicit purpose of identifying the nature of illumination sources as a means to eliminate false alarms from what have been otherwise indistinguishable sources. Machine learning techniques have been applied to video data and discrete/limited band optical but appear to be limited to a flame/no flame determination without explicitly determining the source of the illumination (Recent Advances in Sensor for Fire Detection, Fawad Khan et al., Sensors 2022, Vol 22 and Development of a Model Fire Detection Algorithm, O. S. Ismail et al. Arid Zone Journal of Engineering, Technology and Environment, June 2017, Vol 13(3)).

### SUMMARY

A problem addressed herein is creating a workable method to gather spectra at a frequency and detail and the ability to interpret the spectra in real time in a physically and computationally practical method to both detect flames and other illumination sources and identify the nature of the source of the illumination (i.e., what is emitting the photons that are captured by the spectrometer(s)). By combining a compact high resolution (100s to 1000s of pixelated detectors) spectrometer(s) that samples a wide range of the electromagnetic spectrum (the range can be defined as desired, such as about 1 μm, or 1.5 μm, and up to about 2.3 μm) with the use of task specific artificial intelligence/machine learning models to interpret the signal, a device that can not only identify the presence of flames or other light sources but also identify the nature of the source is realized. Such a method goes beyond the ability of the current commercially available products that are limited to flame/no flame detection and subject to false alarms due to their limited spectral resolution and range.

Compact spectrometers as used in this method are ubiquitous. The more demanding problem is being able to process the signals in a manner that provides useful information. Advances in machine learning and inexpensive compact single board computers/processors powerful enough to execute the models in real time have made artificial intelligence solutions practical. By training machine learning models on thousands or more spectra of light sources generated by combusting materials or other sources of interest both in isolation and combinations, the model can learn how to associate the spectra with the source.

Described herein is a system, device and method that use physically compact optical spectrometer(s) capable of collecting multiple spectra extending over a wide optical range in a fraction of a second in conjunction with artificial intelligence (AI)/machine learning (ML) techniques to interpret the spectra to both identify the presence of flames, fires or other illumination sources and the nature of what is generating the signal being observed. One or multiple spectrometers comprised of 100s to 1000s pixelated detectors provide a near continuum of signal resolution across ranges of the electromagnetic spectrum from the ultraviolet and visible region (approximately 0.2 to 0.8 μm), the near infrared (0.8 to 1.7 μm) and shortwave infrared regions (approximately 1.7 to 2.5 μm). The near continuum of signal resolution affords the ability to interpret the spectra to identify the nature of the illumination source. The instrument operates in real time with the intent of providing both an alarm or diagnostic function and the ability to identify the nature of the illumination source. The ability to identify the nature of the illumination source allows this method to dismiss signals that are not of interest (e.g. a false alarm) or otherwise provide diagnostics beyond those available to similar optical methods used in flame detection that provide a more limited alarm/no alarm utility.

The invention relates to a method to employ compact optical spectrometers suitable for autonomous, continuous operation and installation in interior and exterior settings used in conjunction with artificial intelligence/machine learning techniques to both identify flames, fires or other illumination sources and determine the nature of the illumination source. The spectrometers may operate in one or several of the electromagnetic regions from the ultraviolet (as low as approximately 0.2 μm) to short wave infrared (up to approximately 2.5 μm). This invention is a method that couples existing spectroscopic techniques with the interpretive abilities of artificial intelligence to provide a method to both identify the presence of flames, fires or other light sources in a manner similar to existing optical flame detectors but provides additional functions to determine the nature of the illumination source. The ability to determine the nature of the illumination source can be used to dismiss false alarms or otherwise allow the user to customize their response to the particulars of the observed signal.

Disclosed herein are systems, devices and methods that employ compact (approximately 10 in³), high resolution spectrometers comprised of 100s to 1000s of pixelated detectors that operate from the ultraviolet (approximately 0.2 μm) to the infrared (approximately 1.7 μm) using artificial intelligence/machine learning techniques to both identify the presence of flames or fires and determine the nature of the source of the sensed signal. An imaging or non-imaging spectrometer may be used. The compact spectrometer and the device and system that includes the spectrometer may be sized and packaged to allow it to be installed in commonplace interior locations such as rooms, office spaces, stairwells etc. and exterior locations such as parking lots, open spaces, docks etc. and act primarily but not solely as a flame/fire detection device. The compact spectrometer and the device and system that includes the spectrometer operates without supervision, continuously and in real time. The compact spectrometer and the device and system that includes the spectrometer may be an isolated instrument or connected either wirelessly or wired to a central computer or network of computers.

The compact spectrometer and the device and system that includes the spectrometer is in some examples coupled to a collection optic comprised of some combination of mirrors and lenses the purpose of which is to define the field of view of the spectrometer and direct the signal/light from within the field of view onto the spectrometer. For example, a compact spectrometer and the device and system that includes the spectrometer configured to observe a large area (e.g. parking lot) would have a collection optic suitable for wide field of view while a compact spectrometer and the device and system that includes the spectrometer configured to observe a small area (e.g. a closet) would have a collection optic suitable for narrow field of view. While the spectrometer and optic work together, they are modular in design allowing each to be substituted between multiple instances of the compact spectrometer and the device and system that includes the spectrometer.

The compact spectrometer and the device and system that includes the spectrometer continuously gathers spectra and processes them. The spectra may be transient or stored either in the device or system, or the spectra may be transmitted to another storage medium. The AI/ML algorithms used to interpret the spectra are trained to identify the nature of illumination sources, such as sunlight, incandescent lamps, halogen lamps, gasoline fires, paraffin/candle fires, acetylene/welding torches, cigarettes, wood fires etc. as both individual signals and as combinations of signals. The models can be trained on a time series of spectra collected at a rate of, for example, 10-100 Hz as the stability (flicker) of a light source provides information about the source or a single spectrum. If an imaging spectrometer is used, the spatial information provided may also be used to inform the models. The compact spectrometer and the device and system that includes the spectrometer may operate as a general-purpose instrument trained to identify a variety of illumination sources or explicitly trained to work in specific environments. For example, a compact spectrometer and the device and system that includes the spectrometer configured for use in a coal mine may be optimized for coal and machine oil files and forgo burdening the interpretation algorithm with natural sunlight. A library of AI/ML models each suitable for a different setting may exist allowing the operator to choose the model that best fits their needs.

In one aspect a method, system and device for automatically identifying the nature of a source of electromagnetic radiation includes providing at least one compact spectrometer that is configured to develop at least wavelength versus intensity spectra from sensed input electromagnetic radiation, and using an artificial intelligence (AI)-based system that is configured to identify, from the spectra, the nature of the source of the input electromagnetic radiation.

In an example there is also training of the AI-based system to identify the nature of a plurality of different sources of electromagnetic radiation using at least one machine learning (ML) technique. In an example the ML technique uses at least one of a supervised learning model and an unsupervised learning model.

In an example the AI-based system comprises at least one of a convolutional neural network, a recurrent neural network and a long short-term memory network. In an example the nature of the source of the input electromagnetic radiation comprises a fuel for a flame. In an example the at least one compact spectrometer operates in one or more portions or all of the visible (VIS) and infra-red (IR) range between approximately 0.2 μm and 2.5 μm. In an example the spectra comprise one or more of a single spectrum and a time series of spectra.

In an example the source of the input electromagnetic radiation comprises flames, fires, or other illumination sources, and wherein the AI-based system is further configured to both detect flame and mitigate false alarms associated with flame detection. In an example the AI-based system is trained on data sets of one or more of actual flame and illumination sources recorded as both discrete illumination sources and combinations of multiple illumination sources. In an example there is also the use of the AI-based system to identify the presence of discrete illumination sources in spectra consisting of multiple sources.

In an example the AI-based system is trained using one or more of actual flame spectra, actual illumination spectra, simulated flame sources and simulated illumination sources. In an example the AI-based system is trained on data sets of illumination sources recorded using at least one of a spectrometer and illumination collection optics of a particular configuration that are transformed to appear as they would to at least one of a spectrometer and collection optics of a different configuration.

In an example there is also the provision of multiple compact spectrometers, each comprising either an independently operating instrument, or communicating via a wired or wireless connection to a central control center to monitor an extended area. In an example there is also the processing of the spectra in a remotely located control center that communicates with the spectrometer. In an example the compact spectrometer comprises illumination collection optics that are either directly attached to the spectrometer or detached from the spectrometer and connected to the illumination collection optics via one or more optical fibers.

In an example there is also the provision of other flame detection instruments or sensors to enhance the ability to identify the nature of the source. In an example the other flame detection instruments or sensors are physically separated from the compact spectrometer but collectively communicate to a common processing mechanism to subsequently present themselves as a single instrument. In an example the other flame detection instruments or sensors and the compact spectrometer are physically packaged into a single container.

In an example the AI-based system uses at least one of the spectra and ancillary information collected from an individual or a networked collection of compact spectrometers to update and improve the artificial intelligence models used. In an example the compact spectrometer is an imaging spectrometer that provides spatial information that is used to train the AI-based system.

### BRIEF DESCRIPTION OF THE FIGURES

FIGS. 1A and 1B: Examples of room light (FIG. 1A) and burning match (FIG. 1B) spectra. The spectra are different in both their spectral and temporal qualities.

FIG. 2A: An embodiment of the compact spectrometer and the device and system that includes the spectrometer showing the incident light cast onto the device. The light is focused by a collection optic attached to an enclosure that contains either an imaging or non-imaging spectrometer and support electronics.

FIG. 2B: An embodiment of the compact spectrometer and the device and system that includes the spectrometer showing the incident light cast onto a collection optic detached from the enclosure and using a fiber optic cable to transmit the light to an enclosure that contains a non-imaging spectrometer and support electronics.

FIG. 3. An embodiment where multiple compact spectrometers and the devices and systems that includes the spectrometer communicate via either a wired or wireless connection with a central computer.

FIG. 4. An embodiment of the compact spectrometer and the device and system that includes the spectrometer where it is used alongside other sensors to collectively monitor an area of interest.

FIG. 5A. An embodiment of the compact spectrometer and the device and system that includes the spectrometer that uses a Newtonian telescope as a signal/illumination collection mechanism.

FIG. 5B. An embodiment of the compact spectrometer and the device and system that includes the spectrometer that uses a Cassegrain telescope as a signal/illumination collection mechanism.

### DETAILED DESCRIPTION

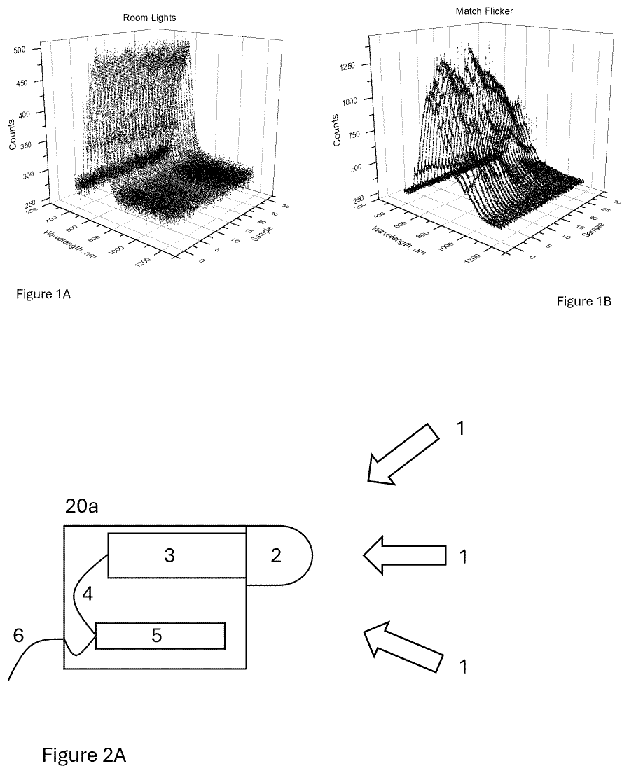

FIGS. 1A and 1B illustrate examples of two sets of spectra one being for conventional room lights (FIG. 1A) and the other (FIG. 1B) a burning match where multiple spectra are collected each second.

Libraries of spectra such as that shown in FIGS. 1A and 1B may assembled by using the compact spectrometer and the device and system that includes the spectrometer in either its final form or one similar enough in performance that the data generated by it is comparable to the compact spectrometer and the device and system that includes the spectrometer. Libraries may also be assembled by using simulated or already existing data bases. The spectra from such sources may require a transformation to cast them into a format that replicates the performance of the compact spectrometer and the device and system that includes the spectrometer. The AI models are trained on these libraries to identify the differences in the spectra and create models that map the input spectra to a particular source. As described, this method is known as supervised learning. Supervised learning is a method where the models are trained with data associated with known values. In this example, the source of the spectra is known and the models are trained to associate the spectra with the known source. However, unsupervised learning may also be employed. In unsupervised learning, the AI models determine without guidance how to categorize the input data. The spectra may be processed by such AI models as but not limited to convolutional neural networks, recurrent neural networks and long short-term memory networks. The networks may be trained on thousands of actual and or simulated flame, fire or other illumination sources both discrete and in combination. When interpreting the spectra, the models generate a numerical score that is a measure of how confident the model is in its determination of the source of the illumination. This confidence measure can then be used to determine the likelihood that a spectra matches a particular illumination source and in some examples can be applied to an alarm mechanism. Other ML techniques may be used.

AI models for different settings can be created by tailoring the training data sets to only those illumination sources that are pertinent to the environment. If the compact spectrometer and the device and system that includes the spectrometer is operating in an environment where any number of flame and illumination sources may be present (e.g. an open space), the models used by the compact spectrometer and the device and system that includes the spectrometer may be trained on an entire collection of illumination spectra. If the compact spectrometer and the device and system that includes the spectrometer is intended to work in a potentially close and defined environment where specific flame threats are anticipated (e.g. a chemical storage locker), then the compact spectrometer and the device and system that includes the spectrometer may be trained on only those spectra that are considered relevant. By training the models with only the necessary spectra, the models are generally more accurate as they are not burdened by having to account for spectra that will not occur. In turn, this allows the operator to adjust how to interpret the confidence scores generated by the AI models. For example, in an environment where a gasoline fire could be expected, a lower confidence score may be accepted as an alarm trigger than in an environment where such a fire is unlikely.

### Exemplary Embodiments

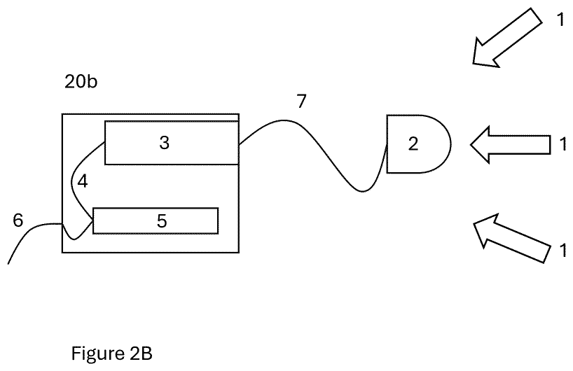

FIGS. 2A and 2B illustrate in a basic manner one non-limiting physical implementation of the compact spectrometer and the device and system that includes the spectrometer. FIG. 2A shows the compact spectrometer and the device and system that includes the spectrometer (20a) as a single assembly while FIG. 2B separates the collection optic from the rest of the instrument (20b) with the two being connected via a fiber optic cable. An imaging or non-imaging spectrometer may be used if the collection optic is directly coupled to the spectrometer as in FIGS. 2A, 3, 4, 5A and 5B. If a fiber optic is used to couple to the spectrometer as in FIG. 2B, a non-imaging spectrometer is used. FIGS. 2A and 2B show the essential components of the compact spectrometer and the device and system that includes the spectrometer (20a); those being a collection optic 2 mounted to an enclosure containing a spectrometer 3 and a computer/processor and support electronics 5. The enclosure and collection optics are suitably weather tight to allow the compact spectrometer and the device and system that includes the spectrometer to be installed in exposed environments.

By way of example, the compact spectrometer and the device and system that includes the spectrometer (e.g., 20a or 20b) may be mounted at the top of a wall observing a workshop. A flame generated by a welding torch (e.g. oxygen/acetylene combustion) casts light 1 onto the collection optic 2. The collection optic directs the light either directly onto the spectrometer 3 or into a fiber optic cable 7 which carries the signal to the spectrometer 3. The spectrometer disperses the light across 100s to 1000s of pixelated detectors generating a wavelength vs. intensity spectrum. The spectrum is recorded 10s to 100s of time each second with each spectrum being transmitted 4 to an internal computer 5. In one embodiment, the internal computer applies a machine learning model to the collection of spectra and determines that both a flame has been detected and that it is being generated by combusting acetylene. The internal computer may then transmit this information 6 to a user specified device if configured to do so or the compact spectrometer and the device and system that includes the spectrometer may act as an isolated instrument. In this example, the acetylene flame (which is considered to be the nature of the source) is considered normal behavior for the workshop and the user has configured the compact spectrometer and the device and system that includes the spectrometer to dismiss the signal. To continue the example, an oil fire is ignited in the workshop. The device identifies the fire and determines that it is an oil fire. An oil fire is not normal behavior and the compact spectrometer and the device and system that includes the spectrometer either triggers an alarm directly and/or the system receiving the information from the compact spectrometer and the device and system that includes the spectrometer does so. The data collection, interpretation and notification process repeats continuously providing real time operation.

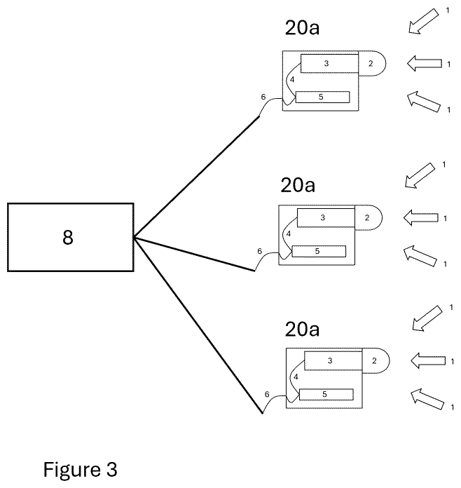

In another embodiment described by FIG. 3, the spectra from devices 20a are transmitted to a central computer 8 which applies the machine learning models remotely from the internal computer of a device 20a.

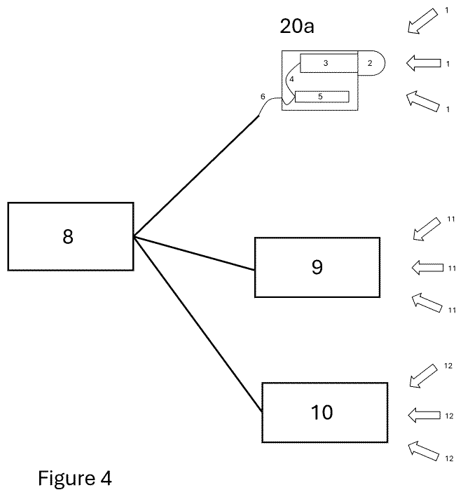

In another embodiment illustrated by FIG. 4, the device 20a is one of several sensors monitoring an environment. Some number of other sensors (two shown) 9 and 10 each designed to recognize inputs 11 and 12 respectively transmit their information to a central computer 8. By way of example the accompanying sensor(s) may be video cameras or particulate based smoke detectors. The central computer may then combine the information from each sensor to inform subsequent data analysis mechanisms or simply aggregate the individual responses. As shown in FIG. 4, the device 20a and other sensors are shown in physically separate enclosures. Multiple physically separate instruments communicating with a centralized system is an embodiment of the use the compact spectrometer and the device and system that includes the spectrometer, but the compact spectrometer and the device and system that includes the spectrometer and accompanying sensors may be packaged into a single enclosure.

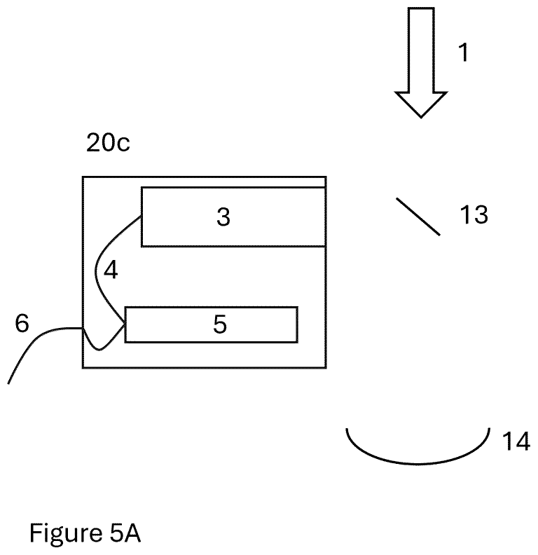

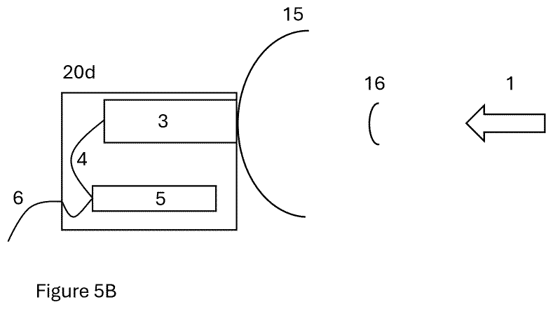

In other embodiments illustrated by FIGS. 5A and 5B, the device (20c and 20d, respectively) uses various telescope configurations to gather the signal/illumination source and direct the signal onto the detector. As shown, the telescope and device are directly attached. The telescope may also be separated from the remainder of the compact spectrometer and the device and system that includes the spectrometer and use a fiber optic to convey the signal between the telescope and the remainder of the compact spectrometer and the device and system that includes the spectrometer. As shown in FIGS. 5A and 5B, the telescopes use mirrors (13, 14, 15, 16) to gather and direct the light 1, but combinations of mirrors and lenses may be used.

In another embodiment, a library of spectra is collected appropriate for spectrometer and/or optical configuration “A” to train the artificial intelligence models used to interpret the spectra gathered by a device using configuration “A”. An alternate configuration “B” perhaps using a spectrometer that has more pixelated detectors than configuration “A” is created. The spectra appropriate for configuration “A” are transformed to appear as they would to configuration “B”. The transformed spectra are then used to train the artificial intelligence models used in configuration “B”.

### LIST OF REFERENCE NUMBERS IN DRAWINGS

1. incident light/signal
2. light collection optic
3. spectrometer
4. internal data and power connection
5. internal computer/processor and support electronics
6. external data and power connection
7. fiber optic cable
8. remotely located computer
9. accompanying sensor of a different design or function as the Device
10. accompanying sensor of a different design or function as the Device
11. signal which the accompanying sensor is intended to recognize
12. signal which the accompanying sensor is intended to recognize
13, 14, 15, 16. Mirrors
20a, 20b, 20c, 20d. different configurations of the compact spectrometer and the device and system that includes the spectrometer.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A method for automatically identifying the nature of a source of electromagnetic radiation, comprising:
providing at least one compact spectrometer that is configured to develop at least wavelength versus intensity spectra from sensed input electromagnetic radiation; and
using an artificial intelligence (AI)-based system that is configured to identify, from the spectra, the nature of the source of the input electromagnetic radiation.

2. The method of claim 1 further comprising training the AI-based system to identify the nature of a plurality of different sources of electromagnetic radiation using at least one machine learning (ML) technique.

3. The method of claim 2 wherein the ML technique uses at least one of a supervised learning model and an unsupervised learning model.

4. The method of claim 1 wherein the AI-based system comprises at least one of a convolutional neural network, a recurrent neural network and a long short-term memory network.

5. The method of claim 1 wherein the nature of the source of the input electromagnetic radiation comprises a fuel for a flame.

6. The method of claim 1 wherein the at least one compact spectrometer operates in one or more portions or all of the visible (VIS) and infra-red (IR) range between approximately 0.2 μm and approximately 2.5 μm.

7. The method of claim 6 wherein the spectra comprise one or more of a single spectrum and a time series of spectra.

8. The method of claim 1 wherein the source of the input electromagnetic radiation comprises flames, fires, or other illumination sources, and wherein the AI-based system is further configured to both detect flame and mitigate false alarms associated with flame detection.

9. The method of claim 1 wherein the AI-based system is trained on data sets of one or more of actual flame and illumination sources recorded as both discrete illumination sources and combinations of multiple illumination sources.

10. The method of claim 1 further comprising using the AI-based system to identify the presence of discrete illumination sources in spectra consisting of multiple sources.

11. The method of claim 1 wherein the AI-based system is trained using one or more of actual flame spectra, actual illumination spectra, simulated flame sources and simulated illumination sources.

12. The method of claim 1 wherein the AI-based system is trained on data sets of illumination sources recorded using at least one of a spectrometer and illumination collection optics of a particular configuration that are transformed to appear as they would to at least one of a spectrometer and collection optics of a different configuration.

13. The method of claim 1 further comprising providing multiple compact spectrometers, each comprising either an independently operating instrument, or communicating via a wired or wireless connection to a central control center to monitor an extended area.

14. The method of claim 1 further comprising processing the spectra in a remotely located control center that communicates with the spectrometer.

15. The method of claim 1 wherein the compact spectrometer comprises illumination collection optics that are either directly attached to the spectrometer or detached from the spectrometer and connected to the illumination collection optics via one or more optical fibers.

16. The method of claim 1 further comprising providing other flame detection instruments or sensors to enhance the ability to identify the nature of the source.

17. The method of claim 16 wherein the other flame detection instruments or sensors are physically separated from the compact spectrometer but collectively communicate to a common processing mechanism to subsequently present themselves as a single instrument.

18. The method of claim 16 wherein the other flame detection instruments or sensors and the compact spectrometer are physically packaged into a single container.

19. The method of claim 1 wherein the AI-based system uses at least one of the spectra and ancillary information collected from an individual or a networked collection of compact spectrometers to update and improve the artificial intelligence models used.

20. The method of claim 1 wherein the compact spectrometer is an imaging spectrometer that provides spatial information that is used to train the AI-based system.
